(19) United States
(12) Patent Application Publication
(10) Pub. No.: US 2017/0207577 A1
(43) Pub. Date: Jul. 20, 2017

(54) ELECTRICAL CONNECTOR APPARATUS HAVING A MALE HOUSING AND A FEMALE HOUSING WITH RIBS

(71) Applicant: J.S.T. Corporation, Farmington Hills, MI (US)

(72) Inventors: Franklin A. HOLUB, West Bloomfield, MI (US); Rajit ABRAHAM, Shelby Township, MI (US); Khalid JABRANE, Novi, MI (US)

(73) Assignee: J.S.T. Corporation, Farmington Hills, MI (US)

(21) Appl. No.: 15/405,654

(22) Filed: Jan. 13, 2017

Related U.S. Application Data
(60) Provisional application No. 62/278,642, filed on Jan. 14, 2016.

(51) Int. Cl. H01R 13/64; H01R 13/436; H01R 43/20

(52) U.S. Cl. CPC H01R 13/64; H01R 43/20; H01R 13/4361

(57) ABSTRACT

An electrical connector apparatus with a protected terminal position assurance device (TPA) provided in the male housing and the female housing, the male housing having a TPA for connecting thereto at least a set of terminals, and the female housing having a TPA for connecting thereto at least a set of terminals. Specifically, the male housing and the female housing of the electrical connector apparatus are designed with ribs and other protective features to prevent the TPA from moving from a pre-set position to a final lock position during shipping and/or handling. The ribs and other protective features of the male housing and the female housing ensure a physical barrier from any contact with the TPA which may alter the position of the TPA.

### BACKGROUND OF THE INVENTION

The present invention generally relates to an electrical connector apparatus with a male housing and a female housing having a terminal position assurance device (TPA). More particularly, the invention is directed to ribs and other protective features provided on the male housing and the female housing to prevent the TPA from moving from a pre-set position to a final lock position.

### SUMMARY OF THE INVENTION

The present invention generally relates to an electrical connector apparatus having a male housing and a female housing, the male housing having a terminal position assurance device (TPA) for connecting thereto at least a set of terminals, and the female housing having a terminal position assurance device (TPA) for connecting thereto at least a set of terminals.

At least a terminal is provided into each of the male housing and the female housing, when each of their respective TPA is at a pre-set position. The set of terminals provided for the male housing is secured thereto when the TPA thereof is placed at the final lock position. Similarly, the set of terminals provided for the female housing is secured thereto when the TPA of the female housing is placed at the final lock position. Thereafter, the male housing and the female housing may be engaged together.

To ensure that the TPA provided in the male housing and the TPA provided in the female housing of the electrical connector apparatus is not moved from a pre-set position to a final lock position during shipping and/or handling, the male housing and the female housing are provided with ribs to protect the TPA from physical contact. These ribs create a physical protective barrier to prevent the TPA from being moved from the pre-set position to the final lock position.

The electrical connector apparatus of the present invention is assembled and packaged in bags in bulk and shipped with the TPA in the pre-set position. This way, the operator can insert terminals into the electrical connector apparatus immediately upon receiving the electrical connector apparatus.

However, since the electrical connector apparatus is packaged and shipped in bulk, various parts can make contact with the TPA during shipping and/or handling which can cause an unprotected TPA from being moved from the pre-set position to the final lock position. If this occurs, the operator of the electrical connector apparatus will have to reset the TPA from the final position to the pre-set position in order to insert the terminals. This causes an inconvenience to the operator as well as wastes time when inserting the terminals into the electrical connector apparatus.

Additional features, advantages, and embodiments of the invention are set forth apparent from consideration of the following detailed description, drawings, and claims. Moreover, it is to be understood that both the foregoing summary of the invention and the following detailed description are exemplary and intended to provide further explanations without limiting the scope of the invention as claimed.

### BRIEF DESCRIPTION OF THE DRAWINGS

FIG. 1 is an exploded perspective view of the electrical connector apparatus of the present invention including the male housing, the female housing, and the TPA.

FIG. 2A is a cross-sectional view of the first embodiment of the present invention showing the male housing of the electrical connector apparatus with the TPA in the pre-set position.

FIG. 2B is a cross-sectional view of the first embodiment of the present invention showing the male housing of the electrical connector apparatus with the TPA in the final lock position.

FIG. 3A is a cross-sectional view of the first embodiment of the present invention showing the female housing of the electrical connector apparatus with the TPA in the pre-set position.

FIG. 3B is a cross-sectional view of the first embodiment of the present invention showing the female housing of the electrical connector apparatus with the TPA in the final lock position.

FIG. 4A is a perspective view of first embodiment of the present invention showing the female housing of the electrical connector apparatus with the TPA in the pre-set position.

FIG. 4B is a perspective view of first embodiment of the present invention showing the female housing of the electrical connector apparatus with the TPA in the final lock position.

FIG. 5A is a perspective view of the first embodiment of the present invention showing the male housing of the electrical connector apparatus with the TPA in the pre-set position.

FIG. 5B is a perspective view of the first embodiment of the present invention showing the male housing of the electrical connector apparatus with the TPA in the final lock position.

FIG. 6 is an exploded perspective view of the second embodiment of the present invention showing the electrical connector assembling including the male housing, the female housing, and the TPA.

FIG. 7 is a perspective view of the second embodiment of the present invention showing the male housing of the electrical connector with the TPA in the pre-set position.

FIG. 8A is a perspective view of the second embodiment of the present invention showing the male housing and the TPA of the electrical connector apparatus.

FIG. 8B is a perspective view of the second embodiment of the present invention showing the male housing of the electrical connector with the TPA in the pre-set position.

FIG. 9A is a cross-sectional view of the second embodiment of the present invention showing the female housing of the electrical connector apparatus with the TPA in the pre-set position.

FIG. 9B is a cross-sectional view of the second embodiment of the present invention showing the female housing of the electrical connector apparatus with the TPA in the final lock position.

FIG. 10A is a cross-sectional view of the second embodiment of the present invention showing the male housing of the electrical connector apparatus with the TPA in the pre-set position.

FIG. 10B is a cross-sectional view of the second embodiment of the present invention showing the male housing of the electrical connector apparatus with the TPA in the final lock position.

FIG. 11A is a perspective view of the second embodiment of the present invention showing the female housing of the electrical connector apparatus with the TPA in the pre-set position.

FIG. 11B is a perspective view of the second embodiment of the present invention showing the female housing of the electrical connector apparatus with the TPA in the final lock position.

### DETAILED DESCRIPTION OF THE PREFERRED EMBODIMENTS

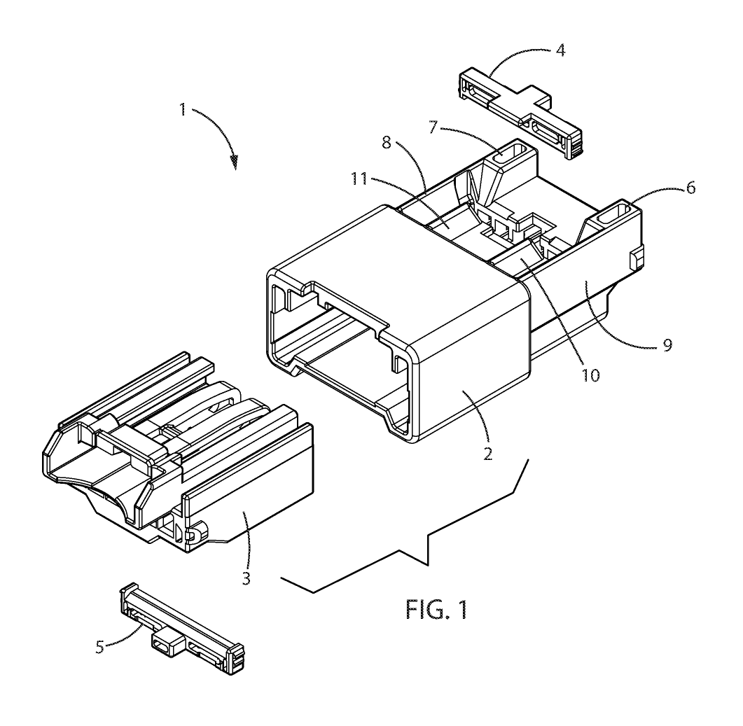

FIG. 1 is an exploded view showing the electrical connector apparatus of the present invention, generally referred to as reference number 1. The electrical connector apparatus 1 includes a male housing 2 and a female housing 3. TPA 4 is provided in the male housing 2 and TPA 5 is provided in the female housing 3. Additionally, FIG. 1 shows ribs 6, 7, 8, 9, 10, and 11 of the male housing 2.

Ribs 6, 7, 8, 9, 10, and 11 are provided on the male housing 2 in order to protect the TPA 4 from any physical contact. Therefore, when the TPA 4 is set in the pre-set position during shipping, the ribs 6, 7, 8, 9, 10, and 11 will prevent the TPA 4 from moving to the final lock position. Furthermore, the ribs 6, 7, 8, 9, 10, and 11 are located on the periphery of the TPA 4 so as to protect the TPA 4 from all sides.

Furthermore, as can be seen in FIG. 1, the male housing has a set of terminal apertures for receiving therein a set of other terminals. The male housing also comprises an opening for receiving the female housing.

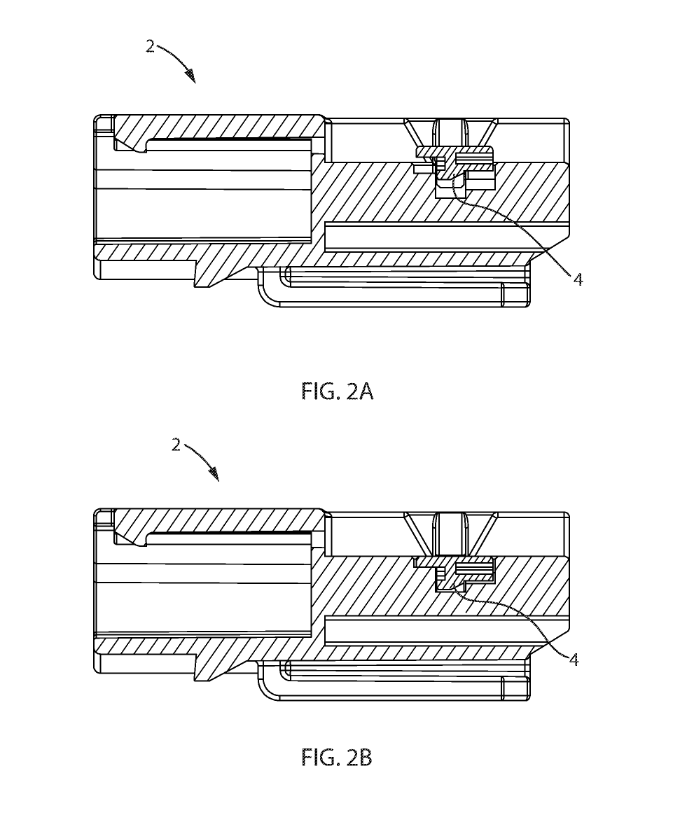

FIG. 2A depicts a cross-sectional view of the male housing 2 in which the TPA 4 is in the pre-set position. This is the position in which the male housing 2 of the electrical connector apparatus 1 is shipped. FIG. 2B shows a cross-sectional view of the male housing 2 in which the TPA 4 is in the final lock position. This final lock position makes inserting the terminals into the electrical connector apparatus more difficult for the operator; therefore, it is preferable that the TPA 4 is not moved to the final lock position during shipping.

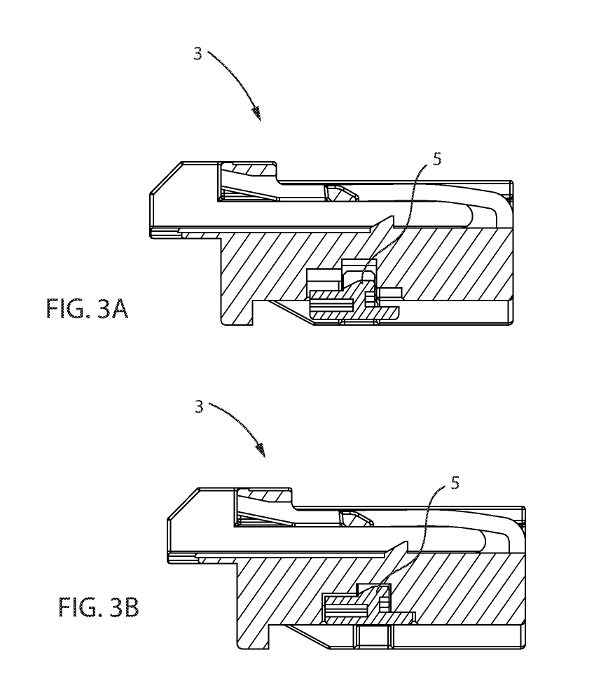

FIG. 3A illustrates a cross-sectional view of the female housing 3 with the TPA 5 in the pre-set position. Similar to the male housing 2, this is the position in which the female housing 3 of the electrical connector apparatus 1 is shipped. FIG. 3B shows a cross-sectional view of the female housing 3 in which the TPA 5 is in the final lock position. As explained above, it is preferable that the TPA 5 is not moved to this final lock position during shipping and/or handling.

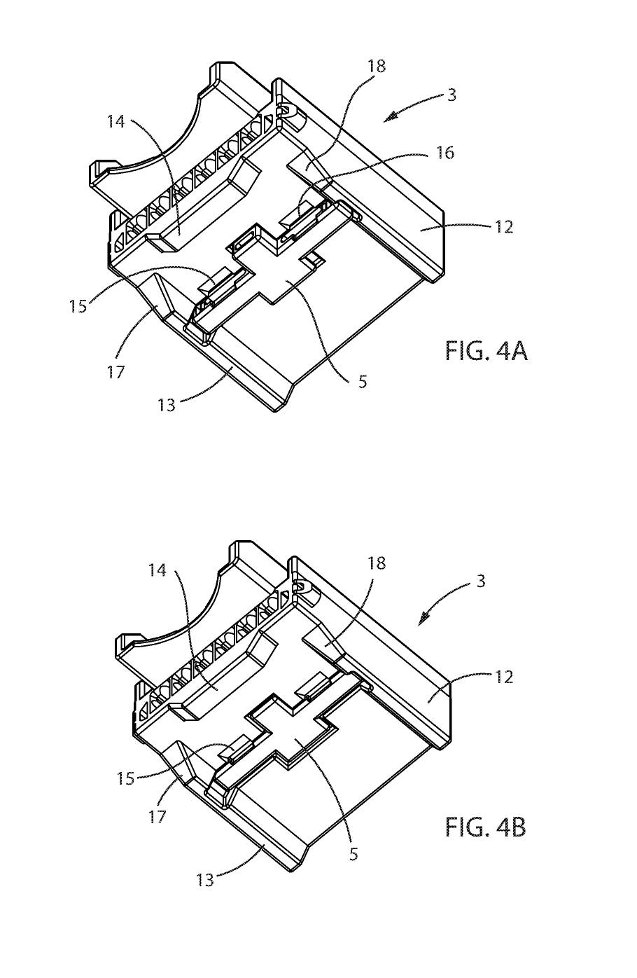

FIG. 4A illustrates a perspective view of the female housing 3 of the electrical connector apparatus 1 showing the TPA 5 in the pre-set position. TPA 5 is located on the bottom, or underneath, of the female housing 3 in a bottom slot. Additionally, the female housing has a set of terminal apertures for receiving therein at least a set of terminals.

FIG. 4A further shows ribs 12, 13, 14, 15, 16, 17, and 18 that are provided on the bottom side of the female housing 3 and that surround the TPA 5 so as to prevent the TPA 5 from being physically pressed down into the final lock position during shipping, handling, or at any other time prior to reaching the operator. The ribs 12, 13, 14, 15, 16, 17, and 18 are located on the periphery of the TPA 5 so as to protect the TPA 5 from all sides. FIG. 4B shows the female housing 3 of the electrical connector apparatus 1 once the TPA 5 has been moved to the final lock position.

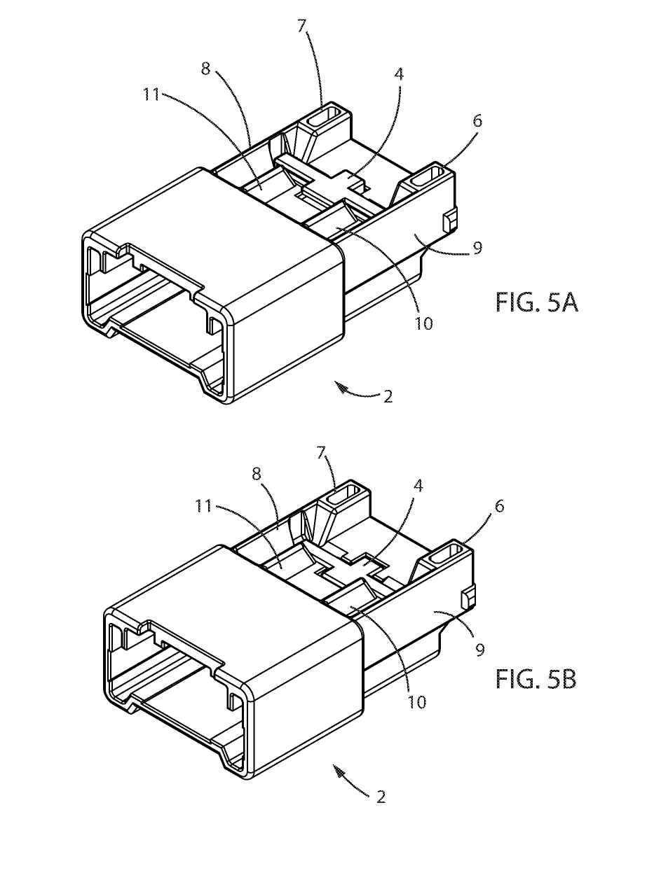

FIG. 5A illustrates a perspective view of the male housing 2 of the electrical connector apparatus 1 showing the TPA 4 in the pre-set position. As can be seen in FIG. 5A, when the TPA 4 is in the pre-set position, during shipping or at any other time, the TPA 4 is protected by the ribs 6, 7, 8, 9, 10, and 11 from all sides. These ribs 6, 7, 8, 9, 10, and 11 are located on the periphery of the TPA 4 so as to protect the TPA 4 from being pressed down into the final lock position. A perspective view of the male housing with the TPA 4 pressed down into the final lock position is shown in FIG. 5B.

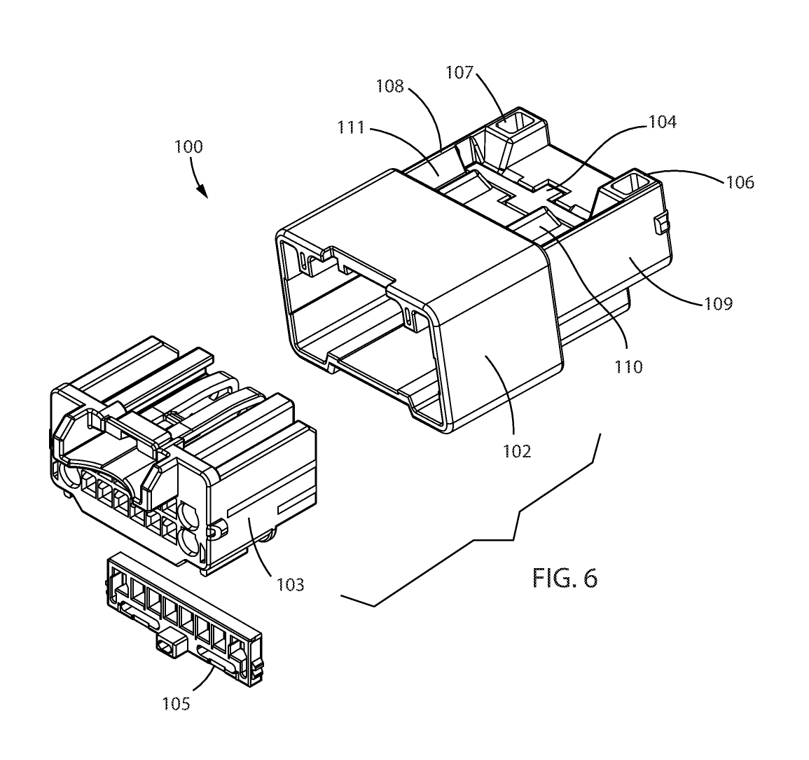

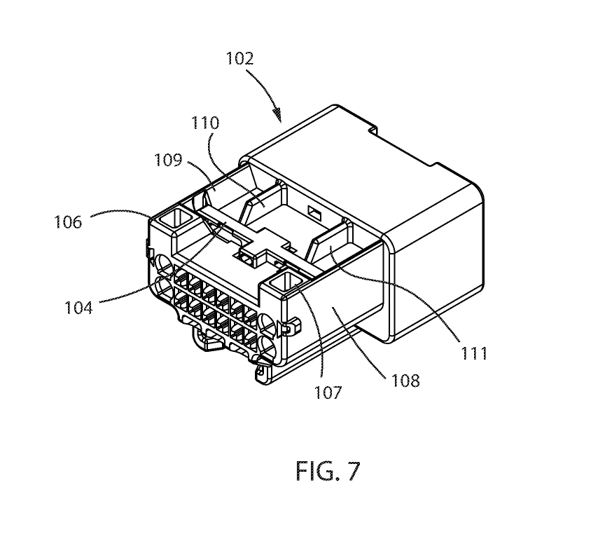

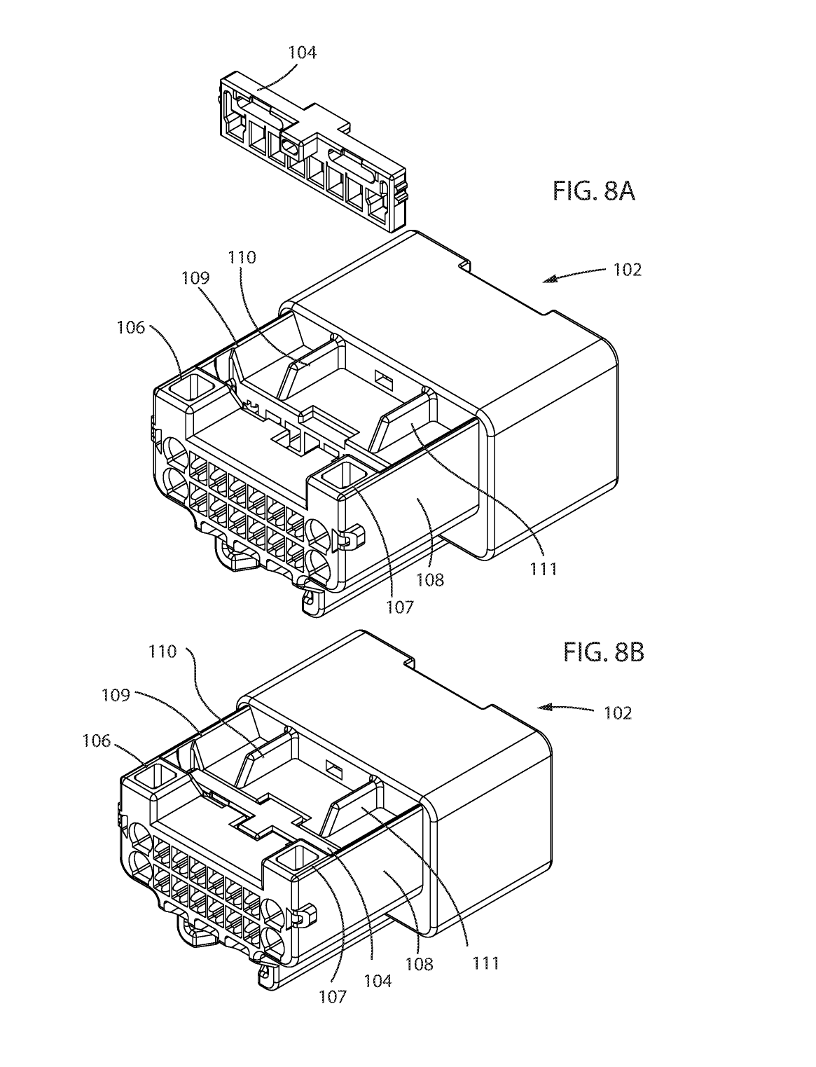

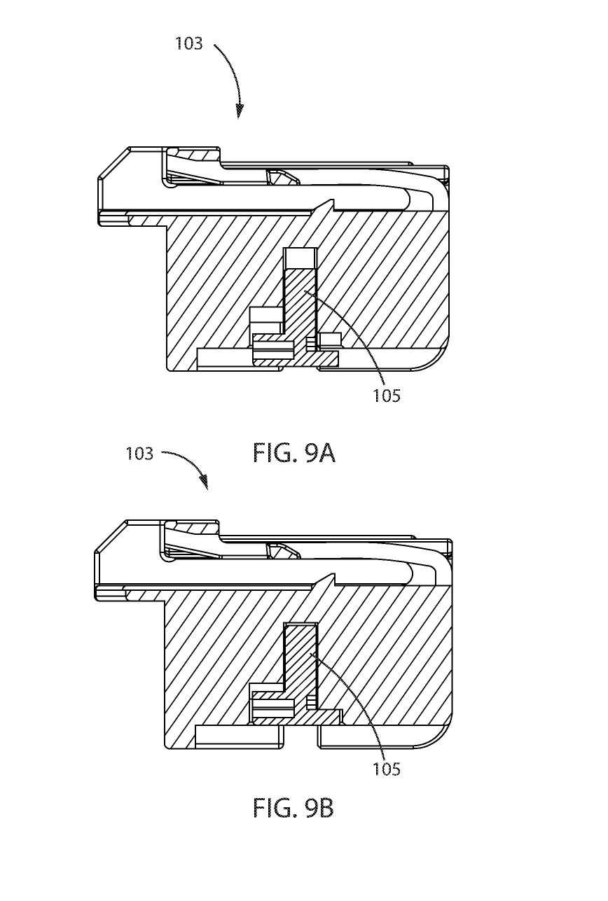

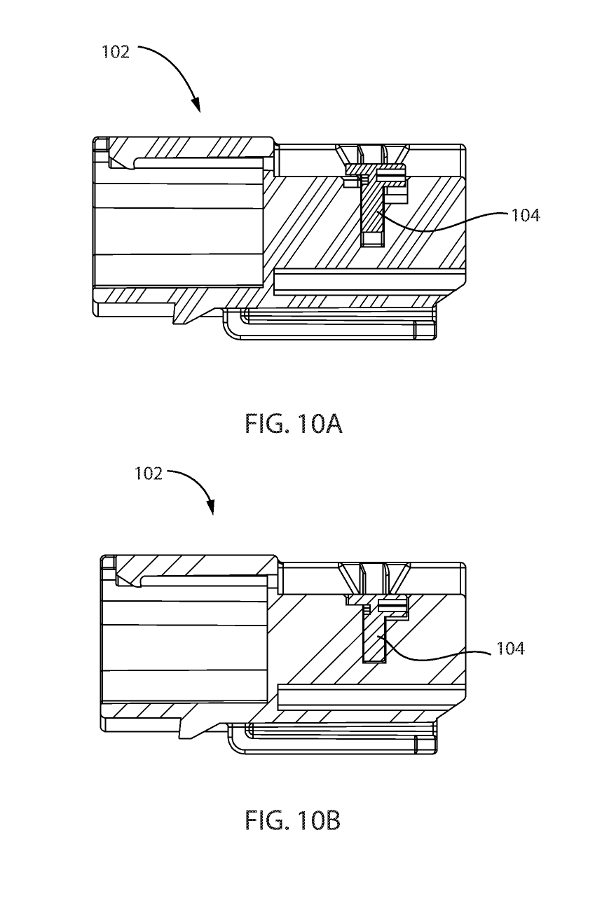

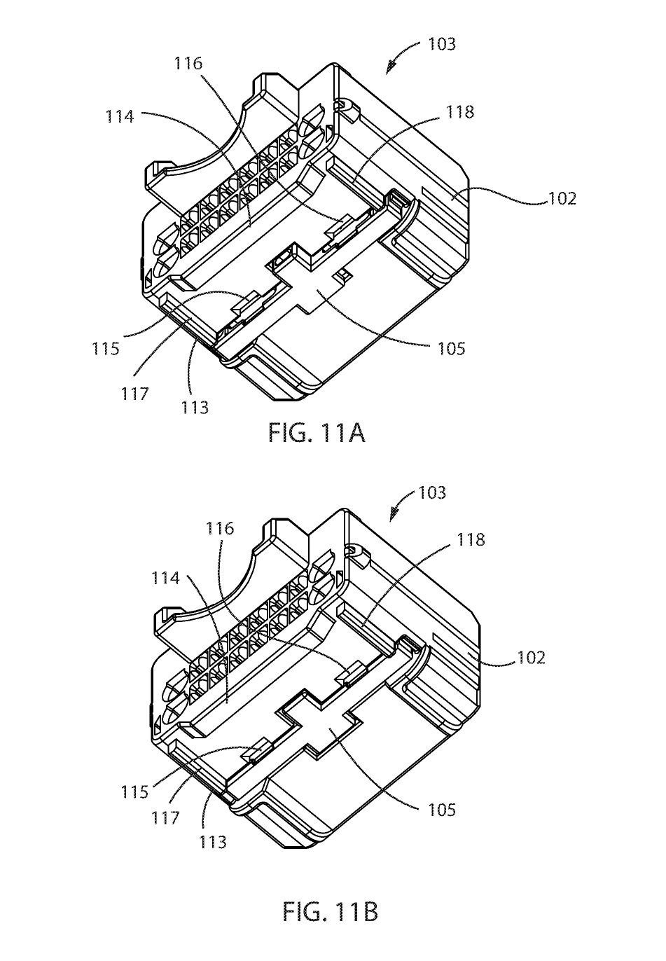

FIG. 6, FIG. 7, FIG. 8A, FIG. 8B, FIG, 9A, FIG. 9B, FIG. 10A, FIG. 10B, FIG. 11A and FIG. 11B illustrate an electrical connector apparatus according to the second embodiment of the present invention. Specifically, the second embodiment of the present invention includes electrical connector apparatus 100, TPA 104, and TPA 105 having 16 pins. However, the present invention is not limited to any specific number of pins for the electrical connector apparatus or TPA.

In the second embodiment of the present invention, the male housing, the female housing, the TPA, and the ribs operate identically to the first embodiment, as detailed above.

Specifically, FIG. 6 illustrates an exploded perspective view of the electrical connector apparatus 100 according to the second embodiment of the present invention. Electrical connector apparatus 100 includes male housing 102, TPA 104, female housing 103, and TPA 105. Furthermore, FIG. 6 shows the ribs 106, 107, 108, 109, 110, and 111 provided on the male housing 102 to protect the TPA 104.

FIG. 7 is a perspective view depicting the male housing 102 of the electrical connector apparatus 100 with the TPA 104 in the pre-set position. Ribs 106, 107, 108, 109, 110, and 111 are provided on the male housing 102 so as to surround the TPA 104 along the periphery of the TPA 104. Ribs 106, 107, 108, 109, 110, and 111 protect the TPA 104 so that the TPA 104 is not moved from a pre-set position to a final lock position during shipping and/or handling.

FIG. 8A illustrates a perspective view of the male housing 102 of the electrical connector apparatus 100 with the TPA 104 removed in order to fully see the placement of the TPA 104 in the male housing 102. FIG. 8B shows the male housing 102 once the TPA 104 has been inserted into the male housing 102 and set in the pre-set position.

The female housing 103 is also provided with ribs 112, 113, 114, 115, 116, 117, and 118 to protect the TPA 103 from being moved from a pre-set position, as shown in FIG. 11A, to the final lock position, as shown in FIG. 11B. These ribs 112, 113, 114, 115, 116, 117, and 118 are located on the periphery of the TPA 103 so as to create a physical barrier to protect the TPA 103 from all sides.

As can be seen in FIGS. 9A and 9B, the TPA 105 of the female housing 103 can be in either a pre-set position or a final lock position. Similarly, the TPA 104 of the male housing 102 can be in either a pre-set position, as shown in FIG. 10A, or a final lock position, as shown in FIG. 10B.

We claim:

1. An electrical connector apparatus, comprising:
a female housing having a set of terminal apertures for receiving therein at least a set of terminals, wherein the female housing comprises a terminal position assurance device (TPA) accommodated within a bottom slot of the female housing, and wherein the female housing further comprises ribs; and
a male housing having a set of terminal apertures for receiving therein a set of other terminals, wherein the male housing comprises an opening for receiving a terminal position assurance device (TPA) and the female housing, and wherein the male housing further comprises ribs,
wherein the ribs provided on the male housing and the ribs provided on the female housing protect the TPA from physical contact.

2. An electrical connector apparatus according to claim 1, wherein the TPA in the female housing includes members for allowing the TPA to be at a pre-set position during transport of the female housing and at a final lock position for engaging the set of terminals.

3. An electrical connector apparatus according to claim 1, wherein the TPA in the male housing includes members for allowing the TPA to be at a pre-set position during transport of the male housing and at a final lock position for engaging the set of terminals.

4. An electrical connector apparatus according to claim 1, wherein the ribs provided on the male housing are located along a periphery of the TPA provided in the male housing.

5. An electrical connector apparatus according to claim 1, wherein the ribs provided on the female housing are located along a periphery of the TPA provided in the female housing.

6. A female housing, comprising:
a bottom slot located underneath the female housing;
a terminal position assurance device (TPA) accommodated within the bottom slot; and
ribs provided on the female housing along a periphery of the TPA to protect the TPA from physical contact.

7. The female housing according to claim 6, wherein the TPA includes members extending therefrom for allowing the TPA to be at a pre-set position during transport of the female housing and at a final lock position for engaging a set of terminals.

8. A male housing, comprising:
an opening for receiving a terminal position assurance device (TPA);
a first end having a set of apertures for accommodating therein a set of terminals;
a second end for receiving the female housing; and
ribs provided on the male housing along a periphery of the TPA to protect the TPA from physical contact.

9. The male housing according to claim 7, wherein the TPA includes members extending therefrom for allowing the TPA to be at a pre-set position during transport of the male housing and at a final lock position for engaging the set of terminals.

10. The male housing according to claim 8, wherein when the TPA is in a final lock position, a female housing can be inserted and accommodated within the second end of the male housing.

11. A method for assembling an electrical connector apparatus, comprising the steps of:
providing a female housing having a set of terminal apertures for receiving therein at least a set of terminals;
accommodating a terminal position assurance device (TPA) within a bottom slot located underneath the female housing;
providing a male housing having a set of terminal apertures for receiving therein a set of other terminals;
accommodating a terminal position assurance device (TPA) within an opening of the male housing; and
accommodating the female housing into the male housing.

12. The method for assembling the electrical connector apparatus according to claim 10, wherein the step of accommodating the TPA within the bottom slot located underneath the female housing further comprises the step of providing the TPA with members extending therefrom for allowing the TPA to be at a pre-set position during transport of the female housing and to be at a final lock position for engaging the set of terminals.

13. The method for assembling the electrical connector apparatus according to claim 10, wherein the step of accommodating the TPA within the opening of the male housing further comprises the step of providing members extending from the TPA for allowing the TPA device to be at a pre-set position during transport of the male housing and at a final lock position for engaging the set of terminals.
